(19) United States
(12) Patent Application Publication
(10) Pub. No.: US 2020/0169706 A1
(43) Pub. Date: May 28, 2020

(54) PROJECTION CONTROL APPARATUS, CONTROL METHOD OF THE SAME, AND PROJECTION SYSTEM

(71) Applicant: CANON KABUSHIKI KAISHA, Tokyo (JP)

(72) Inventor: Makiko Mori, Yokohama-shi (JP)

(21) Appl. No.: 16/685,219

(22) Filed: Nov. 15, 2019

(30) Foreign Application Priority Data
Nov. 28, 2018 (JP) 2018-222683

(51) Int. Cl. H04N 9/31

(52) U.S. Cl. CPC H04N 9/3147; H04N 9/3185

(57) ABSTRACT

A projection control apparatus for controlling projection performed using projectors is disclosed. The control apparatus, for each of the projectors, detects a projection area, being on a projection surface, in which an optical image is projected, based on a captured image of the projection surface. The control apparatus then causes an indicator indicating a target projection area for one of the projectors to be displayed by one or more other projectors. The control apparatus finally determines a projector that is to project the indicator from among the one or more other projectors based on a detection result of the detection.

### BACKGROUND OF THE INVENTION

### Field of the Invention

The present invention relates to a projection control apparatus, a control method of the same, and a projection system, and particularly relates to a technique for adjusting a projection position.

### Description of the Related Art

A method of performing projection with use of multiple projectors (sometimes referred to as “multi-projection”) is known. In multi-projection, the projection position of each projector needs to be adjusted (aligned) individually, and therefore projectors that have a function for facilitating alignment are also known.

Japanese Patent Laid-Open No. 2015-121779 discloses a technique for facilitating the correction of the installation positions of projectors by using a projector that has already been aligned to project a reference image for correcting the installation positions of projectors that have not been aligned.

With the technique disclosed in Japanese Patent Laid-Open No, 2015-121779, at least one projector needs to have already been aligned. This technique therefore cannot be applied in the case where none of the projectors have already been aligned.

### SUMMARY OF THE INVENTION

The present invention provides a projection control apparatus and a control method of the same that make it possible to appropriately adjust the installation positions of multiple projectors even if none of the projectors have been aligned.

According to an aspect of the present invention, there is provided a projection control apparatus for controlling projection performed using projectors, the projection control apparatus comprising one or more processors that execute a program stored in a memory and function as: a detection unit configured to, for each of the projectors, detect a projection area, being on a projection surface, in which an optical image is projected, based on a captured image of the projection surface; and a control unit configured to cause an indicator indicating a target projection area for one of the projectors to be displayed by one or more other projectors, wherein the control unit determines a projector that is to project the indicator from among the one or more other projectors based on a detection result of the detection unit.

According to another aspect of the present invention, there is provided a control method of projection performed using projectors, the control method comprising: detecting, for each of the projectors, a projection area, being on a projection surface, in which an optical image is projected, based on a captured image of the projection surface; and causing an indicator indicating a target projection area for one of the projectors to be displayed by one or more other projectors, wherein in the displaying, a projector that is to project the indicator from among the one or more other projectors is determined based on a detection result of the detecting.

According to a further aspect of the present invention, there is provided a non-transitory computer-readable medium having stored thereon a program for causing a computer to function as a projection control apparatus for controlling projection performed using projectors that comprises: a detection unit configured to, for each of the projectors, detect a projection area, being on a projection surface, in which an optical image is projected, based on a captured image of the projection surface; and a control unit configured to cause an indicator indicating a target projection area for one of the projectors to be displayed by one or more other projectors, wherein the control unit determines a projector that is to project the indicator from among the one or more other projectors based on a detection result of the detection unit.

Further features of the present invention will become apparent from the following description of exemplary embodiments with reference to the attached drawings.

### BRIEF DESCRIPTION OF THE DRAWINGS

FIG. 1 is a schematic diagram showing an example of the configuration of a projection system according to a first embodiment.

FIG. 2 is a block diagram showing an example of the functional configuration of the projection system according to the first embodiment.

FIG. 3 is a diagram illustrating keystone correction.

FIG. 4 is a flowchart illustrating an overview of automatic alignment processing according to the first embodiment.

FIGS. 5A and 5B are diagrams showing examples of a projector selection GUI according to the first embodiment.

FIG. 6 is a diagram showing an example of a camera selection GUI according to the first embodiment.

FIG. 7 is a diagram showing an example of a camera parameter setting GUI according to the first embodiment.

FIG. 8 is a diagram showing an example of an adjustment mode selection GUI according to the first embodiment.

FIG. 9 is a flowchart illustrating installation assistance processing according to the first embodiment.

FIGS. 10A to 10E are diagrams illustrating details of the installation assistance processing according to the first embodiment.

FIGS. 11A to 11D are diagrams illustrating user operations in the installation assistance processing according to the first embodiment.

FIG. 12 is a flowchart illustrating installation assistance processing according to a second embodiment.

FIGS. 13A to 13C are diagrams illustrating details of the installation assistance processing according to the second embodiment.

### DESCRIPTION OF THE EMBODIMENTS

### First Embodiment

Exemplary embodiments of the present invention will now be described in detail in accordance with the accompanying drawings. Note that the present invention is not intended to be limited to the embodiments described below. Also, the constituent elements described in the embodiments are not all necessarily essential to the present invention. Individual function blocks in the embodiments can be realized by hardware, software, or a combination of hardware and software. Also, an individual function block may be realized by multiple pieces of hardware. Moreover, an individual piece of hardware may be realized by multiple function blocks. Furthermore, one or more function blocks may be realized by one or more programmable processors (CPU, MPU, etc.) executing a computer program that has been loaded to a memory. When one or more function blocks are realized by hardware, such hardware can be a discrete circuit or an integrated circuit such as an FPGA or an ASIC.

Also, the graphical user interfaces (GUIs) that are described in the embodiments are merely examples, and it is possible to change the types of components that make up the GUIs and the arrangement of such components, the method of transitioning between GUI screens, and the like.

System Configuration

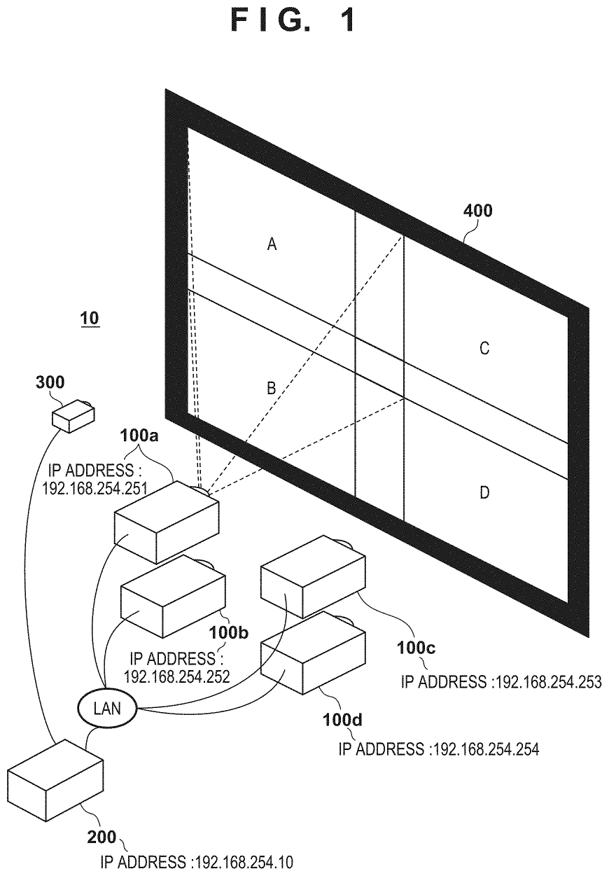

FIG. 1 is a schematic diagram showing an example of a projection system according to an embodiment of the present invention. A projection system 10 is a multi-screen projection system for increasing the size of a projection area while improving the resolution of the projected image and maintaining luminance, for example, Multi-screen projection is a method for causing the projection areas of adjacent projectors to be projected side-by-side. Here, portions of adjacent projection areas are overlapped in order to make the joints between projected images unnoticeable, and dimming processing (edge blending processing) is performed in order to make the increase in luminance in the overlap regions unnoticeable.

Note that the projection system shown in FIG. 1 has four projectors 100a to 100d, and performs multi-screen projection in which projection areas A to D of the four projectors are arranged in a two-by-two grid in the horizontal direction and the vertical direction. However, there are no limitations on the number of projectors and the arrangement of the projection areas. In the following description, when multi-screen projection is performed, the simple term “projector 100” refers to any one or all of the projectors 100a to 100d.

All of the projectors included in the projection system 10 are communicably connected to a personal computer (PC) 200 that functions as a projection control apparatus. Note that another information processing apparatus such as a smartphone or a tablet computer may be used as the projection control apparatus instead of a PC. Also, communication performed between the projection control apparatus and the projectors may be wireless communication or wired communication, and there are no particular limitations on the communication protocol either. As one example in the present embodiment, the projectors 100 and the PC 200 communicate with each other via a local area network (LAN) that uses TCP/IP as the communication protocol.

Also, the PC 200 can control operations of the projectors 100a to 100d by transmitting predetermined commands to the projectors 100a to 100d. The projectors 100a to 100d operate in accordance with the commands received from the PC 200 and transmit the results of such operations to the PC 200.

The projection system 10 further includes a camera 300, which is an image capturing apparatus. The camera 300 may be any camera that can be controlled from the PC 200, such as a digital camera, a web camera, or a network camera. It may also be a camera that is built into the PC 200. The camera 300 is disposed so as to capture images in a fixed range that includes the entirety of a screen 400 that makes up the projection surface. If the camera 300 is separate from the PC 200, the camera 300 can communicate with the PC 200 by wireless or wired communication. Although FIG. 1 shows a configuration in which the camera 300 is directly connected to the PC 200, it may be connected via a network such as a LAN. The PC 200 can control operations of the camera 300 by transmitting predetermined commands to the camera 300. For example, the camera 300 can perform image capturing in accordance with a request from the PC 200 and transmit the obtained image data to the PC 200.

The following terms used in this specification are defined as follows.

Projection area: the area of the projection surface occupied by an optical image projected by one projector 100

Projected image: the optical image projected in a projection area

Projection image: the image signal or image data output by PC 200, or the image expressed by that signal or data

Multi-projection: projection performed using multiple projectors

Composite projection area: the area obtained by compositing the projection areas of multiple projectors in multi-projection

Stack projection: multi-projection in which the projection areas of multiple projectors are matched to each other, or the projected images are completely overlapped with each other

Multi-screen projection: multi-projection in which the projection areas of multiple projectors are arranged side-by-side such that portions of adjacent projection areas overlap each other

Projector: an apparatus that forms a projected image on a projection surface by modulating light from a light source based on a projection image and projecting or scanning the light on the projection surface

Configuration of Projector 100

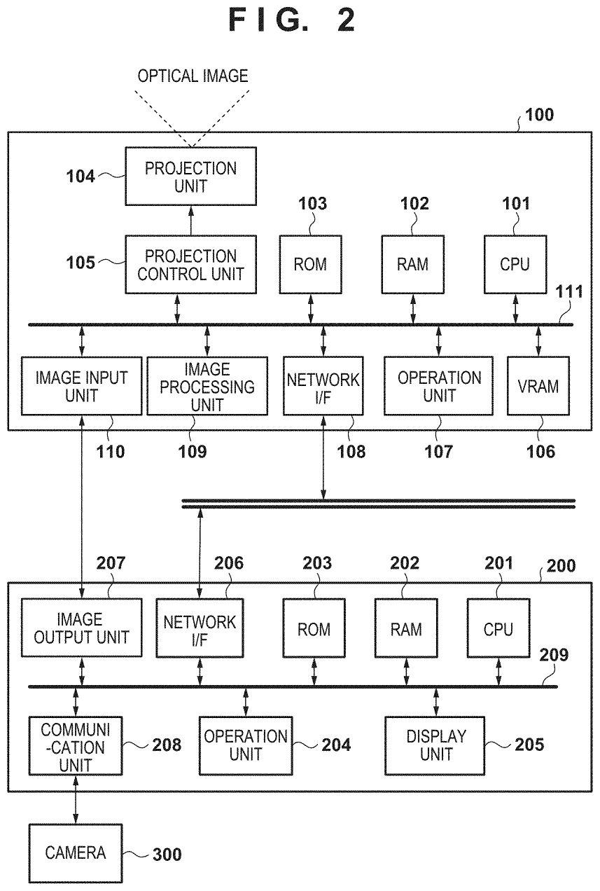

FIG. 2 is a block diagram showing an example of the function configurations of the projector 100 and the PC 200 included in the projection system 10. The projectors 100a to 100d in FIG. 1 have the same configuration, and therefore the following describes the configuration of the projector 100. The projector 100 includes a CPU 101, a RAM 102, a ROM 103, a projection unit 104, a projection control unit 105, a VRAM 106, an operation unit 107, a network IF 108, an image processing unit 109, and an image input unit 110. These function blocks are communicably connected by an internal bus 111.

The CPU 101 is one example of a programmable processor, and realizes operations of the projector 100 by loading a program stored in the ROM 103 to the RAM 102 and executing the program, for example.

The RAM 102 is used by the CPU 101 as a work memory when executing programs. The RAM 102 stores programs, variables used during program execution, and the like. The RAM 102 may also be used for other purposes (e.g., as a data butler).

The ROM 103 may be rewritable. The ROM 103 stores programs executed by the CPU 101, GUI data used for the display of menu screens and the like, and various setting values, for example.

The projection unit 104 includes a light source, a projection optical system, and the like, and projects an optical image based on a projection image that is supplied by the projection control unit 105. In the present embodiment, a liquid crystal panel is used as an optical modulation element, and the reflectance or transmittance of light from the light source is controlled in accordance with a projection image in order to generate an optical image that is based on the projection image and project the optical image onto the projection surface using the projection optical system.

The projection control unit 105 supplies, to the projection unit 104, data regarding a projection image received from the image processing unit 109.

The VRAM 106 is a video memory that stores projection image data received from an external apparatus (e.g., a PC or media player).

The operation unit 107 has input devices such as key buttons, switches, and a touch panel, and accepts user instructions for the projector 100. The CPU 101 monitors operations of the operation unit 107, and when an operation of the operation unit 107 is detected, executes processing that corresponds to the detected operation. Nate that if the projector 100 includes a remote controller, the operation unit 107 notifies the CPU 101 of operation signals received from the remote controller.

The network IF 108 is an interface for connecting the projector 100 to a communication network, and has a configuration that complies with the supported communication network. In the present embodiment, the projector 100 is connected, via the network IF 108, to the same local network as the PC 200. Accordingly, communication between the projector 100 and the PC 200 is executed via the network IF 108.

The image processing unit 109 receives an image signal from the image input unit 110 and stores it in the VRAM 106, applies various types of image processing to the stored image signal as necessary, and supplies the resulting image signal to the projection control unit 105. The image processing unit 109 may be a microprocessor for image processing, for example. Alternatively, functions corresponding to the image processing unit 109 may be realized by the CPU 101 executing a program stored in the ROM 103.

The image processing that can be applied by the image processing unit 109 includes, but is not limited to, frame thinning processing, frame interpolation processing, resolution conversion processing, processing for overlaying an OSD such as a menu screen, keystone correction processing, and edge blending processing.

The image input unit 110 is an interface for directly or indirectly receiving an image signal that is output by an external apparatus (the PC 200 in the present embodiment), and has a configuration that corresponds to the supported image signal. The image input unit 110 includes any one or more among composite terminals, an S-video terminal, a D terminal, component terminals, analog RGB terminals, a DVI-I terminal, a DVI-D terminal, an HDMI (registered trademark) terminal, and the like. Also, if an analog image signal is received, the image input unit 110 converts it to a digital image signal and stores the digital image signal in the VRAM 106.

Configuration of PC 200

Next, the function configuration of the PC 200 will be described. The PC 200 may be a general-purpose computer that can be connected to an external display, and thus has a function configuration that corresponds to a general-purpose computer. The PC 200 includes a CPU 201, a RAM 202, a ROM 203, an operation unit 204, a display unit 205, a network IF 206, an image output unit 207, and a communication unit 208. Also, these function blocks are communicably connected by an internal bus 209.

The CPU 201 is one example of a programmable processor, and realizes operations of the PC 200 by loading a program (OS or application program) stored in the ROM 203 to the RAM 202 and executing the program, for example.

The RAM 202 is used by the CPU 201 as a work memory when executing programs, The RAM 202 stores programs, variables used during program execution, and the like. The RAM 202 may also be used for other purposes (e.g., as a data buffer).

The ROM 203 may be rewritable. The ROM 203 stores programs executed by the CPU 201, GUI data used for the display of menu screens and the like, and various setting values, for example. Note that the PC 200 may include a storage apparatus (HDD or SSD) that has a larger capacity than the ROM 203, and in such a case, a large program such as an OS or an application program may be stored in the storage apparatus.

The operation unit 204 includes input devices such as a keyboard, a pointing device (e.g., a mouse), a touch panel, and switches, and accepts user instructions for the PC 200. Note that the keyboard may be an onscreen keyboard. The CPU 201 monitors operations of the operation unit 204, and when an operation of the operation unit 204 is detected, executes processing that corresponds to the detected operation.

The display unit 205 is a liquid crystal panel or an organic EL panel, for example. The display unit 205 displays screens provided by the OS, an application program, and the like. Note that the display unit 205 may be an external apparatus. Also, the display unit 205 may be a touch display.

The network IF 206 is an interface for connecting the PC 200 to a communication network, and has a configuration that complies with the supported communication network. In the present embodiment, the PC 200 is connected, via the network IF 206, to the same local network as the projector 100. Accordingly, communication between the PC 100 and the projector 200 is executed via the network IF 206.

The image output unit 207 is an interface for transmitting an image signal to an external apparatus (the projector 100 in the present embodiment), and has a configuration that corresponds to the supported image signal. The image output unit 207 includes any one or more among composite terminals, an S-video terminal, a D terminal, component terminals, analog RGB terminals, a DVI-I terminal, a DVI-D terminal, an HDMI (registered trademark) terminal, and the like.

In the present embodiment, the display unit 205 displays the UI screen of a projection control application program that has a function for adjusting the projection area of the projector 100, hut the display unit 205 may display the UI screen on an external device that is connected to the image output unit 207.

The communication unit 208 is a communication interface for performing serial communication or the like with an external device, and is typically a USB interface, but may have a configuration that is compliant with another standard such as RS-232C. Although the camera 300 is connected to the communication unit 208 in the present embodiment, there are no particular limitations on the method of communication between the camera 300 and the PC 200, and communication may be performed therebetween in compliance with any standard that is supported by the two.

Keystone Correction

Next, keystone correction will be described with reference to FIG. 3. Keystone correction is correction (geometric correction) for geometrically transforming (changing the shape of) an original image so as to offset the trapezoidal distortion of a projected image in accordance with deviation between the normal direction of the projection surface and the projection direction (generally the optical axis of the projection optical system). This geometric transformation of an image can be realized using projective transformation, and therefore keystone correction is equivalent to the determination of a projective transformation parameter, which is a correction amount in geometric correction. For example, the CPU 101 can determine a projective transformation parameter based on the movement amounts and the movement directions of the vertices of the original image on a rectangle, and pass the parameter to the image processing unit 109.

For example, letting (xs,ys) be coordinates in the original image, the coordinates (xd,yd) in the projective transformed image are expressed by Expression I below.

$$[ \begin{matrix}xd \\ yd \\ 1\end{matrix} ] = M [ \begin{matrix}xs - xso \\ ys - yso \\ 1\end{matrix} ] + [ \begin{matrix}xdo \\ ydo \\ 0\end{matrix} ] \qquad Expression 1$$

Here, M is a 3×3 matrix for projective transformation from the original image to the transformed image. This matrix M is generally obtained by solving simultaneous equations using the four corner coordinates of the original image and the four corner coordinates of the transformed image. Also, xso and yso are the values of the coordinates of the top-left vertex of the original image (indicated by solid lines in FIG. 3), and xdo and ydo are the values of the coordinates of the vertex in the transformed image (indicated by dashed-dotted lines in FIG. 3) that corresponds to the vertex (xso,yso) of the original image.

Based on the offset (xso,yso),(xdo,ydo) of the matrix M from the inverse matrix M⁻¹, Expression 1 can be transformed into Expression 2 below. The CPU 101 passes the offset (xso,yso),(xdo,ydo) from the inverse matrix M⁻¹ to the image processing unit 109 as the transformation parameter. In accordance with Expression 2, the image processing unit 109 obtains the coordinates (xs,ys) the original image that correspond to the transformed coordinates (xd,yd).

$$[ \begin{matrix}xs \\ ys \\ 1\end{matrix} ] = M [ \begin{matrix}xd - xdo \\ yd - ydo \\ 1\end{matrix} ] + [ \begin{matrix}xso \\ yso \\ 0\end{matrix} ] \qquad Expression 2$$

If the original image coordinate values xs and ys obtained by Expression 2 are both integers, the image processing unit 109 can directly use the pixel value at the original image coordinates (xs,ys) as the pixel value at the coordinates (xd,yd) in the keystone corrected image. However, if the original image coordinate values xs and ys obtained by Expression 2 are not integers, the image processing unit 109 can perform interpolation calculation using the values of surrounding pixels to obtain the pixel value that corresponds to the original image coordinates (xs,ys). This interpolation calculation can be performed using any known interpolation calculation, such as binary or b cubic interpolation. Note that if the original image coordinates obtained using Expression 2 are coordinates in a region outside the original image, the image processing unit 109 uses black (0) or a user-set background color as the pixel value of the coordinates (xd,yd) in the keystone corrected image. In this way, the image processing unit 109 can obtain a pixel value for every coordinate in the keystone corrected image, and thus create a transformed image.

Although the inverse matrix M⁻¹ is supplied to the image processing unit 109 by the CPU 101 of the projector 100 here, a configuration is possible in which the matrix M is supplied, and the inverse matrix M⁻¹ is obtained by the image processing unit 109.

Note that the coordinates of the vertices of the keystone corrected image can be acquired by, for example, allowing the user to input movement amounts using the operation unit 107 such that the vertices of the projected image are each projected at a corresponding desired position. At this time, in order to assist the input of movement amounts, the CPU 201 may use a function of the projection control application program to cause the projector 100 to project a test pattern.

Automatic Alignment Processing

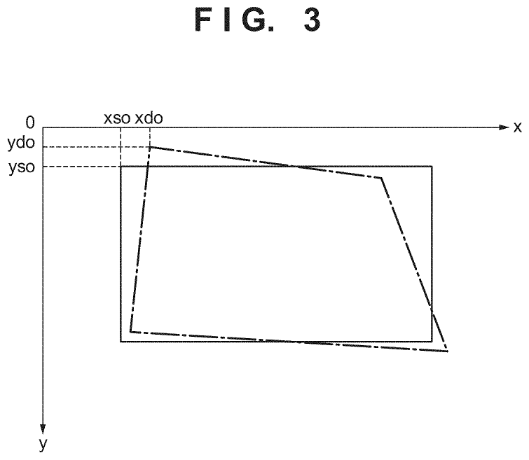

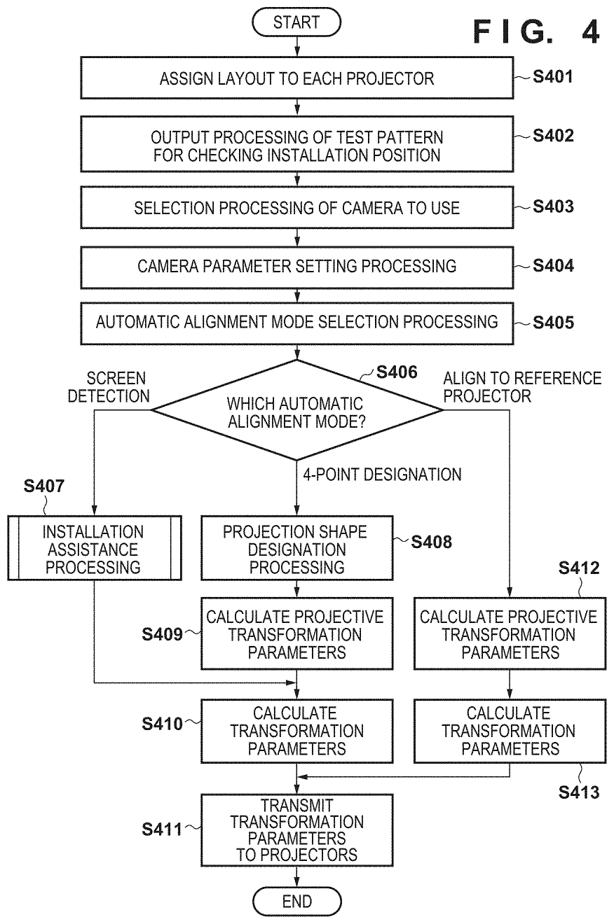

FIG. 4 is a flowchart showing an overview of automatic alignment processing realized by the PC 200 of the present embodiment executing the projection control application program.

In step S401, the CPU 201 of the PC 200 selects multiple projectors that are to be subjected to automatic alignment processing from among the projectors 100 with which the PC 200 can communicate, and selects a layout.

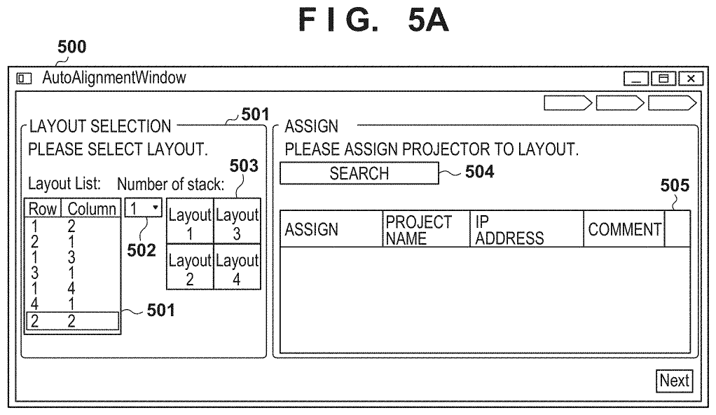

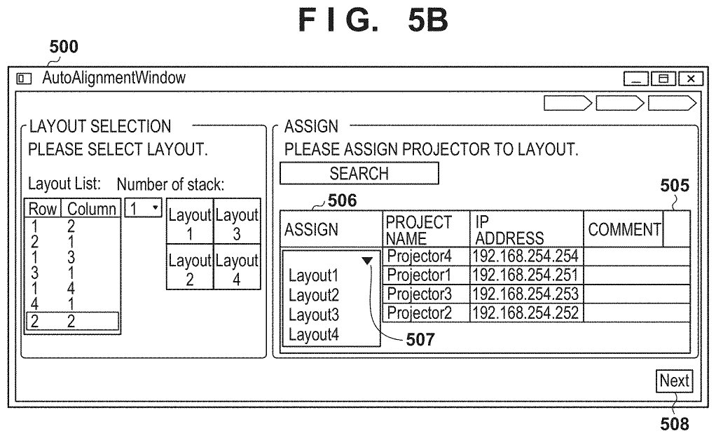

FIG. 5A is a diagram showing an example of a GUI screen 500 that is displayed on the display unit 205 by the CPU 201 executing the projection control application program (hereinafter simply called the application). The user can perform operations on the GUI screen 500 via the operation unit 204 of the PC 200.

A layout list 501 displays a list of arrangements of projection areas in multi-screen projection using various combinations of the number of projection areas arranged in the vertical direction (Row) and the number of projection areas arranged in the horizontal direction (Column). Although the layout list shown here envisions multi-screen projection using two to four projectors, a layout list including layouts corresponding to a larger number of projectors may be presented. Also, a configuration is possible in Which projector detection processing is executed in response to the launch of the application, the operation of a later-described search button 504, or the like, and then a layout list 501 that corresponds to the number of detected projectors is generated.

In the present embodiment, multi-screen projection is performed using the four projectors 100a to 100d, and the projection areas thereof are to be arranged two each in the vertical direction and the horizontal direction, and therefore the user selects the combination of Row:2 and Column:2 from the layout list 501. This selection can be performed through a known method using a pointing device or a keyboard.

Upon detecting the selection operation performed on the layout list 501, the CPU 201 specifies the selected layout. The CPU 201 then displays a layout chart 503 that corresponds to the selected layout. The layout chart 503 is a chart that illustratively shows the positional relationship between projection areas on the projection surface. In the example shown in FIGS. 5A and 5B, layout numbers (Layout1 to Layout4) denote areas that indicate the individual projection areas in the layout chart 503. Hereinafter, the terms “projection area” and “layout area” are synonymous.

A stack number dropdown 502 is a GUI part for setting the number of projectors that are to be used for each layout area when applying stack projection to the individual layout areas (projection areas) in multi-screen projection. Here, stack projection is not used, and one projector is to be used for each layout area, and therefore the initial value 1 remains unchanged,

The search button 504 is a GUI button for allowing the user to instruct the PC 200 to search for controllable projectors. If it is detected that the search button 504 was pressed, a predetermined command that requests information regarding a projector name and an IP address is broadcast by the CPU 201 to the LAN via the network IF 206. Note that the requested information is not limited to the projector name and the IP address, and the command can also request apparatus states such as an edge blending setting value and keystone transformation values, and apparatus information such as a model name and capabilities, for example.

The CPU 101 of each projector 100 connected to the LAN receives the command via the network IF 108, and transmits data that includes the requested information to the PC 200. The CPU 201 of the PC 200 receives the data that was transmitted in response to the command, and displays the information included in the data in a list view 505 (FIG. SB). Here, projector names and IP addresses are displayed in the list view 505, but other information may be displayed as well. The projector information displayed in the list view 505 may be sorted in the order in which the commands were received, or may be sorted in accordance with another condition.

Note that as previously mentioned, a configuration is possible in which projector detection processing is executed when the application launches, and the projector information is displayed in the list view 505 when the GUI screen 500 is first displayed. Also, projector detection processing may be executed in accordance with a condition other than the condition that the search button 504 was operated.

Here, only the projectors 100a to 100d that are to be used in multi-screen projection are connected to the LAN, and therefore only the projectors 100a to 100d (projector names Projector1 to Projector4) are displayed in the list view 505. However, if other projectors are connected to the LAN, information regarding them is also displayed in the list view 505.

If projector information is displayed in the list view 505, a dropdown button 507 is displayed in an assign field 506 for each piece of projector information. FIG. 5B shows the state where the dropdown button 507 that corresponds to the top row (Projector4) in the list view 505 has been operated.

When operation of the dropdown button 507 is detected, the CPU 201 displays a drop list for selecting the layout area that is to be assigned to the projector that corresponds to the dropdown button 507 that was operated. Here, none of the layout areas have been assigned to any of the projectors, and therefore all of the layout areas from Layout1 to Layout4 can be selected. Projector4 has the IP address 192.168.254.254 and corresponds to the projector 100d in FIG. 1.

The user therefore selects Layout4, which corresponds to the projection area D in FIG. 1, from the pulldown list. Then Layout1, Lavout2, and Layout3 are similarly set for the projectors 100a to 100c. In this way, the user uses the dropdown buttons 507 to assign a layout area to each projector that is to be used in multi-screen projection among the projectors that are displayed in the list view 505.

The CPU 201 stores, in the RAM 202 for example, the information that was acquired from the projectors (e.g., projector names and IP address) and information regarding the relationship between the layout areas and the projectors. Note that if a layout area has been assigned to a projector from which at least either edge blend information or keystone transformation amounts have not been acquired, the CPU 201 transmits a request command to that projector to acquire the missing information, and stores the acquired information in the RAM 202.

When the assignment of layout areas to the projectors is complete, the user presses a Next button 508 shown in FIG. 5B, Upon detecting that the Next button 508 was pressed, the CPU 201 moves to test pattern output processing in step S402 in FIG. 4.

In step S402, the CPU 201 transmits, via the network IF 206, a test pattern display command to each of the projectors that were assigned a layout area, and then moves to the processing of step S403. At this time, the CPU 201 also transmits a keystone transformation cancellation command to each projector in which keystone transformation is being applied (the keystone transformation amounts are not zero).

Here, the projectors may be caused to display any test pattern as long as it assists checking the sizes and positions of the projection areas of the projectors, and a grid image may be used for example. The command for instructing the display of the test pattern may be a command that designates the test pattern, a group of commands for rendering the test pattern, or a command that transmits a test pattern image as projection image data. The test pattern may be different for each projector, or may be the same for all of the projectors.

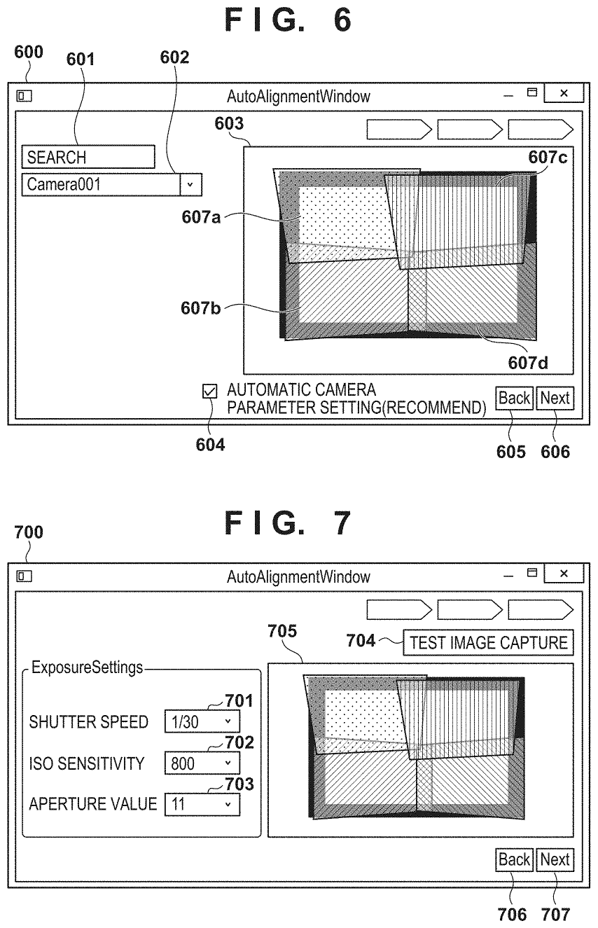

In step S403, the CPU 201 displays a camera selection screen 600 shown in FIG. 6 for example on the display unit 205. The camera selection screen 600 is a screen that allows the user to select the camera that is to be used in automatic alignment processing. Upon detecting an operation performed on a search button 601 in the camera selection screen 600, the CPU 201 searches for devices that are connected to the communication unit 208 or the network IF 206 of the PC 200, and acquires identification information (e.g., a camera product name) of any cameras that are connected. The CPU 201 may then display a dialog on the camera selection screen 600 to inform the user that search processing has ended.

The CPU 201 then prepares the acquired camera information as items in a dropdown list 602, and upon detecting an operation performed on the dropdown list 602, displays a list of selectable camera information. The user can then select the camera that is to be used in automatic adjustment by selecting a desired piece of camera information from among the pieces of camera information that are displayed in the dropdown list 602. Note that a configuration is possible in which two or more cameras can be selected for use in automatic adjustment.

An image area 603 in the camera selection screen 600 is an area that displays an image captured by the camera that was selected in the dropdown list 602. For example, the CPU 201 transmits an image capture command to the camera that was selected via the dropdown list 602 (here, the camera 300 in FIG. 2). The camera 300 executes image capture processing in response to the command, and outputs the captured image to the PC 200. The CPU 201 receives the image data via the communication unit 208, and displays the image data in the image area 603 of the camera selection screen 600.

It is desirable that the image acquired from the camera 300 is a live-view image (real-time moving images), but the acquired image may be a still image. FIG. 6 shows an example in which projection areas 607a to 607d of the projectors 100a to 100d appear in the image displayed in the image area 603. This figure illustratively shows the case where different test patterns are projected by the projectors in order to facilitate the identification of the projection area of each projector, but the test patterns may be the same as previously mentioned.

The user can reference the image displayed in the image area 603 and easily adjust the installation position and angle of view of the camera such that the projection areas of all of the projectors fit within the imaging range of the camera 300.

Upon detecting an operation performed on a Back button 605 in the camera selection screen 600, the CPU 201 displays the GUI screen 500 instead of the camera selection screen 600. The CPU 201 then returns to the processing of step S401.

A checkbox 604 in the camera selection screen 600 allows the user to select whether or not to cause the PC 200 to automatically calculate the imaging parameters (aperture, shutter speed, sensitivity, etc.) of the camera 300. Here, it is assumed that ON (the PC 200 automatically calculates the imaging parameters) is selected by default.

A Next button 606 is for allowing the user to instruct the CPU 201 to move to the next screen. Upon detecting an operation performed on the Next button 606, the CPU 201 checks whether or not the checkbox 604 is checked. If the checkbox 604 is checked, the CPU 201 executes imaging parameter automatic calculation processing. Although there are no particular limitations on the method for automatically calculating the imaging parameters, as one example, the CPU 201 can cause each of the projectors 100 to project a predetermined test pattern, and acquire imaging parameters that are obtained by an automatic exposure control function of the camera 300.

Then, upon detecting an operation performed on the Next button 606, the CPU 201 moves to the processing of step S404 in FIG. 4, and executes imaging parameter setting processing. For example, the CPU 201 displays a parameter setting screen 700 shown in FIG. 7 on the display unit 205. The parameter setting screen 700 includes dropdown lists 701 to 703 for corresponding imaging parameters that are to be set in the camera 300. The dropdown lists 701 to 703 respectively correspond to the shutter speed, the ISO sensitivity, and the aperture (f-stop). Note that the number of and types of imaging parameters that can be set may differ according to the camera model, for example. For example, a configuration is possible in which other types of imaging parameters such as the white balance and photometry system can be set.

If the CPU 201 has determined that the checkbox in FIG. 6 is checked, and has accordingly executed imaging parameter automatic calculation processing, the CPU 201 displays the values obtained through the automatic calculation processing as the initial values in the dropdown lists 701 to 703. If imaging parameter automatic calculation processing has not been executed, CPU 201 displays predetermined values as the initial values in the dropdown lists 701 to 703. Note that when displaying the parameter setting screen 700, the CPU 201 may cause the camera 300 to perform image capturing with use of the imaging parameters displayed as the initial values in the dropdown lists 701 to 703, and display the obtained image in an image area 705. Accordingly, the user can determine whether or not the imaging parameters need to be changed without giving another test image capture instruction.

Upon detecting an operation performed on a test image capture button 704 in the parameter setting screen 700, the PC 200 transmits, to the camera 300, a command for executing image capturing with use of the parameters that are selected in the dropdown lists 701 to 703 at that time. An image captured by the camera 300 in response to the command is then acquired and displayed in the image area 705. This image capturing is for the evaluation of the parameters, and therefore the CPU 201 instructs the camera 300 to execute still image capturing. Note that the camera 300 may be instructed to perform moving image capturing.

Upon detecting an operation performed on the Back button 706, the CPU 201 switches from the parameter setting screen 700 to the camera selection screen 600 and returns to the processing of step S403.

Upon detecting an operation performed on the Next button 707, the CPU 201 moves to the processing of step S405, and executes automatic alignment mode selection processing. In step S405, the CPU 201 selects an automatic alignment mode. In the present embodiment, any one of “4-point designation”, “screen detection”, and “align to reference projector” can be selected as the automatic alignment mode.

In the “4-point designation” mode, the user designates the outer shape of the target composite projection area. The keystone correction amounts of the projectors are then automatically determined such that the composite projection area conforms to the designated outer shape. This 4-point designation adjustment is useful in the case where the position of the target composite projection area is clear and can be designated by the user. The user can designate the outer shape of the target composite projection area by designating the positions of the four vertices of a rectangle, for example. Note that a configuration is possible in which the coordinates of five or more points, including coordinates other than vertices, can be designated.

In the “screen detection” mode, the screen area is detected in an image captured by the camera 300, and the keystone correction amounts of the projectors are automatically determined such that the composite projection area conforms to the screen area. This is useful in cases where the screen area (target composite projection area) can be detected in the image, such as cases where the background and the screen have different colors, or a framed screen such as the screen 400 in FIG. 1 is used. The present embodiment is mainly related to projector arrangement assistance processing in the case of using this mode. If the “screen detection” mode is selected, the CPU 201 displays, on the display unit 205, the message “Arrange the screen so as to completely fit inside the imaging range of the camera, and then press the Next button.”

in the “align to reference projector” mode, one projector is set as the reference projector, and the keystone correction amounts are automatically determined such that the projection areas of the other projectors conform to the projection area of the reference projector. In the case of multi-screen projection, the keystone correction amounts of the other projectors are determined so as to align the overlap areas of the projection area of the reference projector and the projection areas of the other projectors. Also, in the case of stack projection, the keystone correction amounts of the other projectors are determined such that the projection areas of the other projectors match the projection area of the reference projector. Unlike the “4-point designation” mode, this mode is useful in the case where the position of the target composite projection area is not clear (e.g., projection on a wall surface).

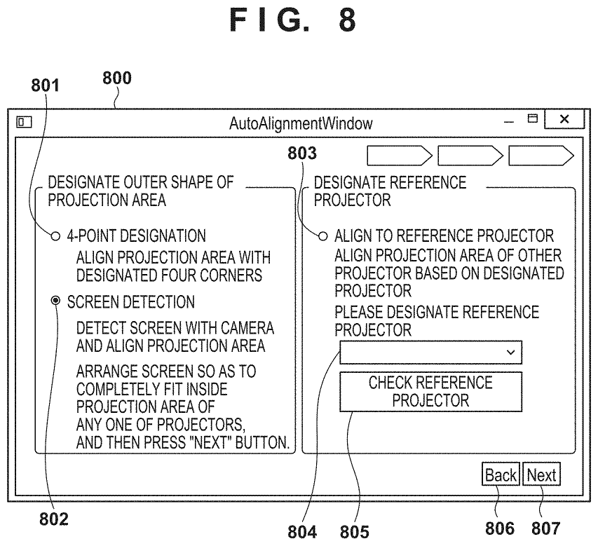

FIG. 8 shows an example of an automatic alignment mode selection screen 800. The CPU 201 of the PC 200 switches between which automatic alignment mode is to be used for adjustment in accordance with which of radio buttons 801, 802, and 803 is selected. Information regarding the selected automatic alignment mode is stored in the RAM 202 by the CPU 201 of the PC 200.

A dropdown list 804 in FIG. 8 is for selecting the reference projector. The projectors that can be selected here are the projectors that were selected as targets of alignment processing in step S401 in FIG. 4. The user selects one desired projector from the dropdown list, and the CPU 201 of the PC 200 stores information indicating the selected projector as the reference projector in the RAM 202.

Upon detecting an operation performed on a “Check reference projector” button 805 in FIG. 8, the CPU 201 of the PC 200 transmits, via the network IF 108, a specified test pattern display command to each of the projectors that were selected as targets of alignment processing. At this time, the reference projector is caused to display a pattern that has a different color, brightness, shape, or the like from the patterns displayed by the other projectors such that the user can easily check based on the projected images which of the projectors is the reference projector.

Note that as previously mentioned, the present embodiment relates to projector installation assistance processing in the case where the automatic alignment mode has been set to the “screen detection” mode, and therefore automatic alignment performed using the reference projector will not be described in detail.

Upon detecting an operation performed on a Back button 806, the CPU 201 switches from the automatic alignment anode selection screen 800 to the parameter setting screen 700, and returns to the processing of step S404.

Upon detecting an operation performed on a Next button 807, the CPU 201 moves to the processing of step S406, and then moves to different branches of processing based on the automatic alignment mode that was selected in step S405. The CPU 201 moves to installation assistance processing in step S407 if the automatic alignment mode is the “screen detection” mode, moves to step S408 if the automatic alignment mode is the “4-point designation” mode, and moves to step S412 if the automatic alignment mode is the “align to reference projector” mode.

Installation Assistance Processing

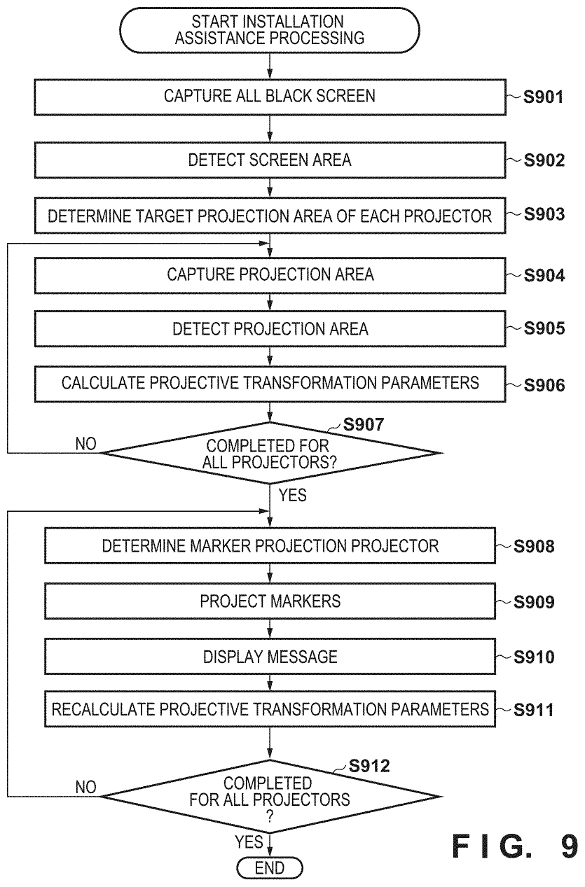

FIG. 9 is a flowchart showing details of installation assistance processing in step S407 in FIG. 4. This processing can be executed even if none of the projectors have been aligned.

In step S901, the CPU 201 (control means) of the PC 200 transmits an all-black image display command to all of the projectors to which a layout area was assigned in step S401 in FIG. 4. The CPU 201 then transmits an image capture command to the camera 300, and acquires a captured image that includes the screen 400. Note that a light source OFF command may be transmitted instead of the all-black image display command.

Next, in step S902, the CPU 201 analyzes the image that was acquired in step S901, and detects the area of the screen 400 (excluding the frame portion) the target composite projection area. Note that there are no particular limitations on the method of detecting the area of the screen 400 based on an image, and it is possible to use any known method such as detecting a rectangular area using image binarization processing, edge detection, graphic element detection, or the like.

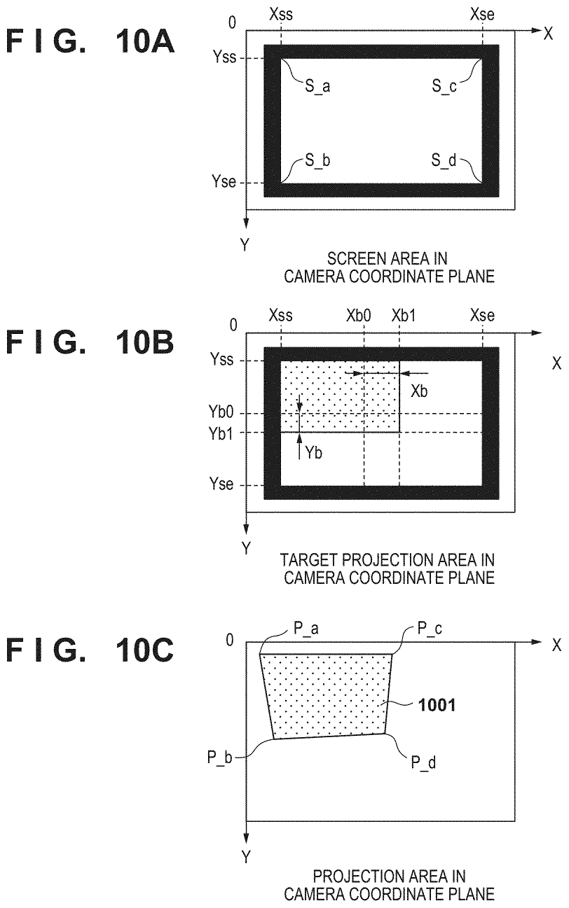

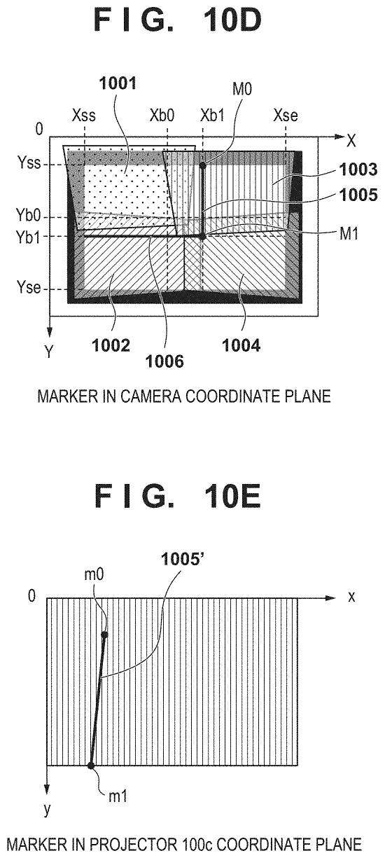

FIG. 10A illustratively shows the coordinates of a screen area that was detected in step S902 based on the image that was captured in step S901. Here, in order to simplify the description, assume that the camera 300 faces the screen 400 straight on. In this example, the screen area is shaped as a rectangle having the top-left vertex (Xss,Yss) and the bottom-right vertex (Xse,Yse) in the camera coordinate plane.

In step S903, the CPU 201 determines a target projection area for each of the projectors 100a to 100d based on the layout areas that were set in step S401 and the edge blending setting. Here, edge blending is a technique for making overlap areas unnoticeable when the edges of adjacent projection areas are overlapped with each other in multi-screen projection. Control parameters in edge blending include the overlap side and width, the overlap area dimming curve, and the like.

In the case of the 2×2 layout in the present embodiment, the sides that are subjected to edge blending are the right side and the bottom side for the projector 100a, the top side and the right side for the projector 100, the left side and the bottom side for the projector 100c, and the left side and the top side for the projector 100d. Also, the widths of the overlap areas are the same in the X direction and the same in the Y direction. The parameters of edge blending may be acquired together with model information and the like from the projectors, or values selected by the user via an application running on the PC 200 may be set in the projectors by the CPU 201.

FIG. 10B shows the coordinates of the target projection areas of the projectors in the camera coordinate plane, Here, Xb and Yb are the widths of the overlap areas in the X direction and the Y direction. The CPU 201 determines that the target projection area of the projector 100a is a rectangular area having (Xss,Yss) and (Xb1,Yb1) as the vertices across the diagonal, and this rectangular area is shown with a dot pattern. The CPU 201 also determines that the target projection area of the projector 100b is a rectangular area having (Xss,Yb0) and (Xb1,Yse) as the vertices across the diagonal. The CPU 201 also determines that the target projection area of the projector 100c is a rectangular area having (Xb0,Yss) and (Xse,Yb1) as the vertices across the diagonal, and determines that the target projection area of the projector 100d is a rectangular area having (Xb0,Yb0) and (Xse,Yse) as the vertices across the diagonal. The CPU 201 stores information indicating the determined target projection areas of the projectors in the RAM 202.

In step S904, similarly to step S402 for example, the CPU 201 transmits a test pattern display command to one projector used in multi-screen projection. The CPU 201 also transmits an image capture command to the camera 300, and acquires a captured image that includes the screen 400. Note that a test pattern that is different from the test pattern used in step S402 may be used.

In step S905, the CPU 201 detects the projection area of the projector that was caused to display the test pattern in step S904. The CPU 201 obtains a difference image between the captured image that was acquired in step S904 and the captured image that was acquired in step S901. This difference image shows the projection area of the projector that was caused to display the test pattern in step S904.

FIG. 10C shows an example of a current projection area 1001 of the projector 100a, as shown by the difference image. For example, by obtaining the vertices of the area not having a value of 0 in the difference image, it is possible to obtain the coordinates of the vertices of the projection area (P_a, P_b, P_c, P_d) in the camera coordinate system. The coordinates of the vertices of the projection area may he obtained using another method. In this way, the CPU 201 detects the projection area of each projector. The CPU 201 stores the projection area detection results in the RAM 202.

In step S906, the CPU 201 obtains a projective transformation parameter (projective transformation matrix) for converting the vertex coordinates of the projection area in the camera coordinate system, which were obtained in step S905, into values in the projector coordinate system. Coordinate values in the projector coordinate system have values in a range that corresponds to the panel resolution of the projector. The projective transformation parameter can be obtained similarly to the keystone correction projective transformation matrix that was described with reference to FIG. 3. Although keystone correction is transformation on the same coordinate plane, and coordinate conversion between different coordinate planes is performed in step S906, the two are the same in sense of being projective transformation of two quadrangles. The CPU 201 stores the obtained projective transformation parameter in the RAM 202.

In step S907, the CPU 201 determines whether or not steps S904 to S906 have been executed for all of the projectors to which a layout area was assigned in step S401. The CPU 201 returns to the processing of step S904 if a projector not subjected such processing exists, and moves to the processing of step S908 if all of the projectors have been subjected to such processing.

In step S908, the CPU 201 determines a marker projection projector from among the projectors 100b to 100d, that is to say a projector that is to project an indicator (assist marker, which is hereinafter also simply be called a marker) for adjusting the installation position of the projector 100a.

FIG. 10D shows an example of current projection areas 1001 to 1004 of the projectors 100a and 100d and assist markers 1005 and 1006 for the projector 100a in the camera coordinate plane. The assist markers 1005 and 1006 are indicators that serve as guides for the target projection area of the projector whose installation position is to be adjusted (here, the projector 100a).

Here, the assist markers 1005 and 1006 are images that show, out of the four sides making up the border of the target projection area of the projector 100a that was determined in step S903, at least the sides that that are not overlapped with the frame of the screen 400 or the border of the screen area. Although the case where the markers are solid lines is shown here, the markers may be dashed lines or dotted lines, or may have another pattern. Also, the markers do not need to be straight lines, and may be shaped as corner brackets (e.g., “┌” and “┘”).

The CPU 201 searches for a projector that is to project the assist markers 1005 and 1006 (marker projection projector) from among the projectors that are performing multi-screen projection, excluding the projector whose installation position is to be adjusted. Specifically, based on the projection area detection results, for each marker, the CPU 201 searches for a projector whose current projection area includes a predetermined ratio or more (e.g., 50% or more) of the marker projection range (i.e., searches for the projector that can project the predetermined ratio or more of the markers). The CPU 201 then determines the corresponding projector to be the marker projection projector. If a corresponding projector does not exist, the CPU 201 may again perform a search to determine whether the predetermined ratio or more of one marker can be projected using a plurality of projectors, and determine a plurality of marker projection projectors for that one marker.

in the example in FIG. 10D, the entirety of the projection range of the assist marker 1005 is included in the current projection area 1002 of the projector 100c, and the entirety of the projection range of the assist marker 1006 is included in the current projection area 1003 of the projector 100b. Accordingly, the CPU 201 determines that the projector 100c is the marker projection projector for the assist marker 1005, and that the projector 100b is the marker projection projector for the assist marker 1006.

In step S909, the CPU 201 causes the marker projection projectors that were determined in step S908 to project the markers. Specifically, for each marker, the CPU 201 converts the coordinates of the marker in the camera coordinate plane into coordinates in the projector coordinate plane with use of the projective transformation parameter of the marker projection projector that was obtained in step S906. The CPU 201 then transmits, to the marker projection projector, a rendering command that includes the configuration of the marker (e.g., marker shape, marker rendering line, and type of pattern) and the coordinates of the marker. Alternatively, the CPU 201 may composite a marker image on the image that is the source of the image signal that is supplied to the marker projection projector.

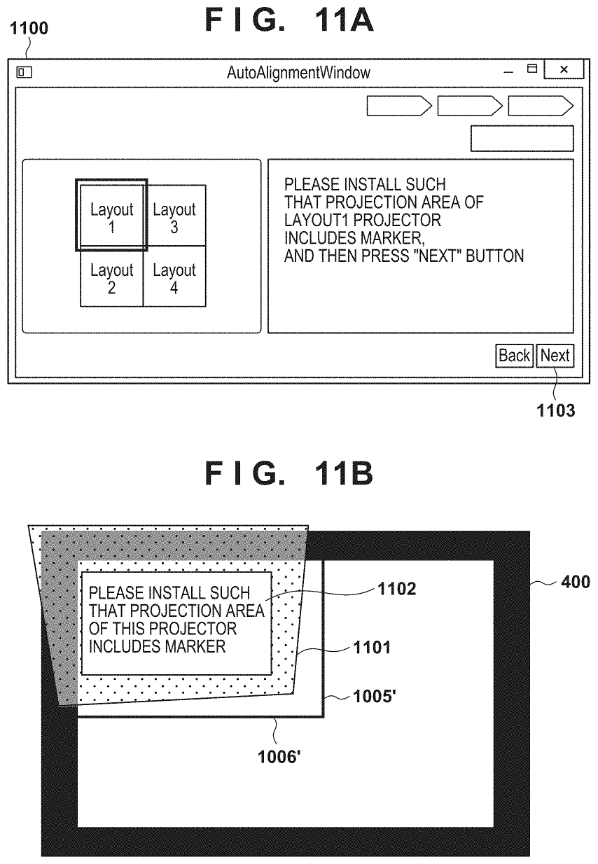

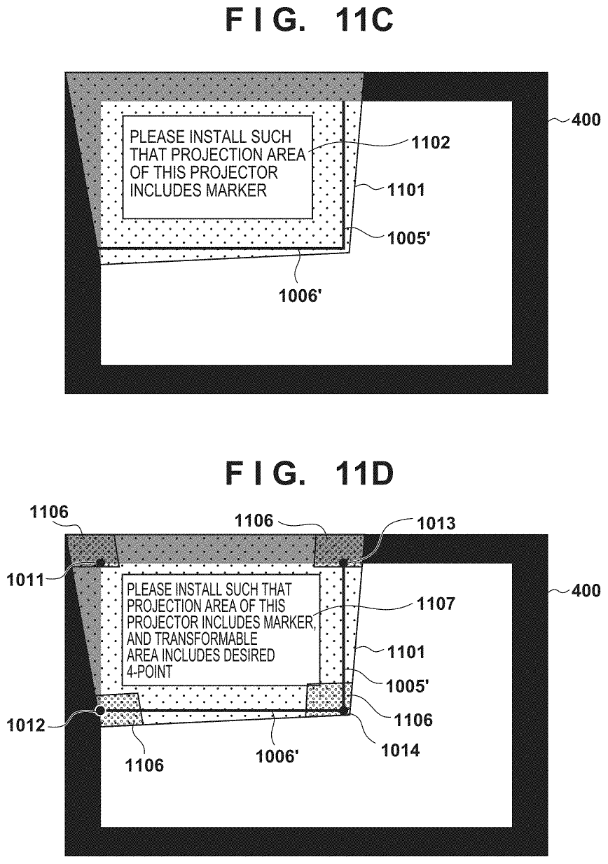

FIG. 10E shows an assist marker 1005′ that is shown when the assist marker 1005 is projected in the coordinate plane of the projector 100c. The CPU 201 projects the coordinates of two ends MO and MI of the linear assist marker 1005 in the camera coordinate plane onto the coordinate plane of the projector 100c using the projective transformation matrix that was obtained in step S906. Assume that the coordinates m0 and m1 are obtained. In this case, the CPU 201 causes the projector 100c to project a straight line that connects the coordinates m0 and m1 as the assist marker 1005′. Accordingly, the assist marker 1005′ is projected at a position on the screen 400 that corresponds to the edge of the target projection area of the projector 100a (FIG. 11B). The CPU 201 similarly causes the projector 100b to project the assist marker 1006 as well. An assist marker 1006′ is thus projected on the screen 400 (FIG. 11B).

In step S910, the CPU 201 displays an application message screen 1100 shown in FIG. 11A for example on the display unit 205. The message screen 1100 includes a message that prompts the user to adjust the installation position of the projector 100a such that the projection area includes the projected markers. Note that the message may be projected onto the screen 400 by any of the projectors.

FIG. 11B shows an example in which a message screen 1102 is projected. on the screen 400 by the projector 100a whose installation position is to be adjusted. In this figure, 1101 denotes the current projection area of the projector 100a.

In accordance with the message screen 1100 and/or the message 1102, the user moves the body of the projector 100a and adjusts the leg height and projection optical system such that the assist markers 1005′ and 1006′ are included in the projection area 1101. FIG. 11C illustratively shows an example of the state after adjustment of the installation position of the projector 100a. When the adjustment of the installation position of the projector 100a is complete, the user presses a Next button 1103 in the message screen 1100 shown in FIG. 11A via the operation unit 204.

Upon detecting the pressing of the Next button 1103, the CPU 201 moves to the processing of step S911. The CPU 201 then executes processing that is the same as steps S904 to S906, and recalculates a projective transformation parameter for the coordinate plane of the adjusted projector 100a and the camera coordinate plane. The projective transformation parameter obtained here is used in step S909 if the projector 100a projects assist markers for the other projectors 100b to 100d.

Next, in step S912, the CPU 201 determines whether or not installation position adjustment has been completed for all of the projectors that are to be used in multi-screen projection (projectors to which a layout area was assigned in step S401). If it is determined that there is a projector for which adjustment is not complete, the CPU 201 changes the projector whose installation position is to be adjusted, and returns to the processing of step S908. On the other hand, if it is determined that there are no projectors for which adjustment is not complete, the CPU 201 ends the installation assistance processing, and moves to the processing of step S410 (FIG. 4). In this way, through the installation assistance processing of the present embodiment, the projectors can be easily installed at positions for realizing the target projection area even if none of the projectors have been aligned.

Note that a configuration is possible in which, if there is a limit on the keystone transformation amount that can be applied in the projector whose installation position is to be adjusted for example, another marker is presented in order to assist the adjustment of the installation position through keystone transformation such that the target projection area can be realized. FIG. 11D shows an example in which markers 1106, which indicate the range in which the four vertices of the projection area can be moved through the keystone transformation function of the projector 100a, are projected in step S909. The markers 1106, which indicate the range in which the vertices can be moved through the keystone transformation function of the projector 100a, can be generated based on information regarding the keystone transformation capability that is acquired from the projector whose position is to be adjusted. Keystone transformation is transformation for moving vertices inward, and therefore the markers 1106 can of course be projected by the projector whose installation position is to be adjusted. Accordingly, in the example in FIG. 11D, the markers 1106 can be projected by the projector 100a.

In the case of using the markers 1106, in step S910, a message 1107 is displayed in order to prompt the user to adjust the installation position such that the assist markers 1005 and 1006 are included in the current projection area, and furthermore the four vertices of the target projection area are all included in the areas indicated by the markers 1106. Here, the four vertices of the target projection area are the points denoted by 1011 to 1014 in FIG. 11D, and are the end points of the assist markers 1005′ and 1006′ (three vertices) and the top-left vertex of the target composite projection area, By adjusting the installation position of the projector 100a such that the four vertices of the target projection area are included in the areas of the markers 1106, it is possible to ensure that the projector 100a can realize the target projection area through the keystone transformation function of the projector 100a.

According to the installation assistance processing described above, when adjustment of the installation positions of the projectors 100a to loud is complete, in step S410 (FIG. 4). the CPU 201 executes transformation parameter calculation processing. For each of the projectors, the CPU 201 calculates a keystone transformation parameter for matching the projection area of the projector to the target projection area that was obtained in step S903 in FIG. 9. Specifically, the CPU 201 projects the vertex coordinates of the target projection area in the camera coordinate plane stored in the RAM 202 onto the coordinate plane of the projector in order to obtain image vertex coordinates after keystone transformation (target vertex coordinates) in the projector. The CPU 201 then calculates a keystone transformation parameter for matching the image vertex coordinates before keystone transformation to corresponding target vertex coordinates.

In step S411, the CPU 201 transmits the keystone transformation parameters, which were calculated in step S410 for the projectors 100a to 100d, to the corresponding projectors 100a to 100d via the network IF 206. The CPU 101 of each projector receives the keystone transformation parameter from the PC 200 via the network IF 108, transmits the received keystone transformation parameter to the image processing unit 109, and executes display image transformation.

Note that the above description pertains to the case of matching the projection area to the target projection area using only the keystone transformation function of the projector. However, another function of the projector, such as a zoom function or a shift function, may be used instead of the keystone transformation function or in addition to the keystone transformation function. It is not often the case that the projection area can be matched to the target projection area using only an optical zoom function or a shift function, but these functions do not involve image processing, and therefore result in less image degradation than in the case of using the keystone transformation function. A reduction in the image quality of the projected image can be suppressed by using the zoom function or the shift function along with the keystone transformation function so as to minimize the keystone transformation amounts.

The following is a brief description of processing in the case where the automatic alignment mode is the “4-point designation” mode and the case where the automatic alignment mode is the “align to reference projector” mode in step S406.

If the automatic alignment mode is the “4-point designation” mode, the CPU 201 executes projection shape designation processing in step S408.

Specifically, the CPU 201 causes makers for designating the shape of the target composite projection area to be projected onto the screen 400 by a projector 100, and allows the positions of the markers to be adjusted by the user. When a setting end instruction is accepted from the user, the composite projection area specified by the positions of the markers at that time is set as the target composite projection area. The CPU 201 then determines the target projection areas of the projectors in a manner similar to the processing in step S903. Next, in step S409, similarly to steps S904 to S907 in FIG. 9, the CPU 201 successively calculates projective transformation parameters for conversion between the coordinate systems of the projectors and the camera coordinate system, and then moves to the processing of step S410. The processing of step S410 and the subsequent steps is the same as described above.

Also, if the automatic alignment mode is the “align to reference projector” mode, in step S412, the CPU 201 successively calculates projective transformation parameters for conversion between the coordinate systems of the projectors and the camera coordinate system similarly to steps S904 to S907 in FIG. 9. Next, in step S413, the CPU 201 successively calculates transformation parameters for the projectors other than the reference projector such that predetermined overlap areas of projection areas that are adjacent to the projection area of the reference projector are overlapped with a predetermined overlap area of the projection area of the reference projector, and then moves to the processing of step S411.

Note that in order to simplify the description and understanding thereof, the case where the screen 400 and the camera 300 face each other straight on (the case where the optical axis of the camera and the screen are orthogonal to each other) is described in the present embodiment. However, it is not essential that the camera 300 faces the screen 400 straight on in the present embodiment. If the camera 300 does not face the screen 400 straight on, it is sufficient that the camera coordinate system is projected onto a plane that is parallel with the screen, and the above-described processing is executed in the screen-parallel coordinate system.

Also, in the present embodiment, installation position adjustment processing is always executed for each projector to which a layout area is assigned. However, installation position adjustment may be omitted for a projector whose current projection area includes the target projection area. It should be noted that if image quality is to be prioritized, installation position adjustment is performed on all projectors, including projectors whose current projection area includes the target projection area. This is because by performing installation position adjustment such that the target projection area included in the projection area is as large as possible, it is possible to minimize the keystone transformation amounts.

Note that the present embodiment describes installation assistance processing for performing installation position adjustment such that the projection area of a projector can be automatically aligned with a target projection area with use of the keystone transformation function, the zoom function, the shift function, or the like of the projector. However, the user may manually adjust the keystone transformation amounts, the zoom amounts, and the shift amounts and adjust the installation positions of the projectors while referencing the assist markers that are projected in installation assistance processing, in order to set the projection areas to the target projection areas. In this case, automatic alignment does not need to be executed.

As described above, according to the present embodiment, in order to assist projector installation position adjustment performing multi-projection, a projector that is different from the adjustment target projector is used to project an indicator that serves as a guide that indicates the position of the target projection area of the adjustment target projector. For this reason, by adjusting the installation position of the adjustment target projector while visually comparing the indicator and the current projection area, it is possible for the projection area of the adjustment target projector to be easily and reliably aligned with the target projection area even if none of the projectors have been aligned. In particular, the current projection area of each projector is detected based on a captured image of the projection surface, and the projector that is to project the indicator is determined based on the detection results, and therefore the indicator can be appropriately displayed even if none of the projectors have been aligned. A target projection area guide has not conventionally existed, and therefore sometimes re-installation has been necessary, but in the present embodiment, such a situation can be avoided, and the installation time can be shortened. Multi-projection requires that all of the projectors are correctly installed, and therefore the higher the number of projectors is, the greater the effect of the present embodiment is.

### Second Embodiment

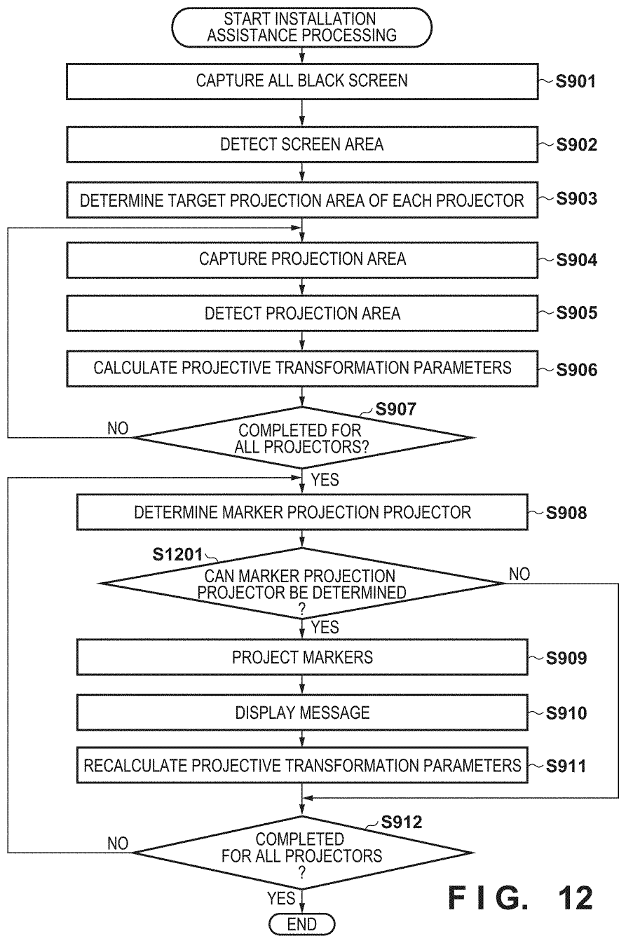

Next, a second embodiment of the present invention will be described. The present embodiment describes processing in the case where a projector that can project the assist markers is not found. Portions of the configuration of the projection system, the automatic alignment processing overview, the GUI screens of the automatic alignment application, and the like that are the same as in the first embodiment will not be described. FIG. 12 is a flowchart of installation assistance processing in the present embodiment. The processing of steps S901 to S908 is similar to that in the first embodiment, and therefore will not be described.

In step S1201, the CPU 201 determines whether or not a projector that can project assist markers for a projector targeted for installation position adjustment could be determined in step S908. For example, the CPU 201 moves to step S909 if it is determined that a marker projection projector could be determined for all of the markers, and moves to step S912 if a marker projection projector could not be determined for one or more markers. Note that as previously described, the marker projection projector is the projector, or group of projectors, that can project a predetermined ratio or more (e.g., 50% or more) of the marker projection range.

The processing of steps S909 to S912 is the same as in the first embodiment. If a marker projection projector cannot be determined in step S908, the processing of steps S909 to S911 is skipped. Accordingly, the projector that is the target of installation position adjustment is changed in step S912, and then processing is repeated from step S908. If a marker projection projector cannot be determined, it is often the case that there are many projectors whose installation positions have not been adjusted. As the number of projectors whose installation positions have been adjusted increases, the probability of being able to determine a marker projection projector increases. Accordingly, by beginning installation position adjustment with a projector for which a marker projection projector can be determined, it is possible to successively determine a marker projection projector for even projectors for which a marker projection projector could not initially be determined.

In this way, in the present embodiment, installation position adjustment s postponed for a projector for which an indicator serving as a target projection area guide could not be projected, thus making it possible for installation position adjustment to be performed efficiently.

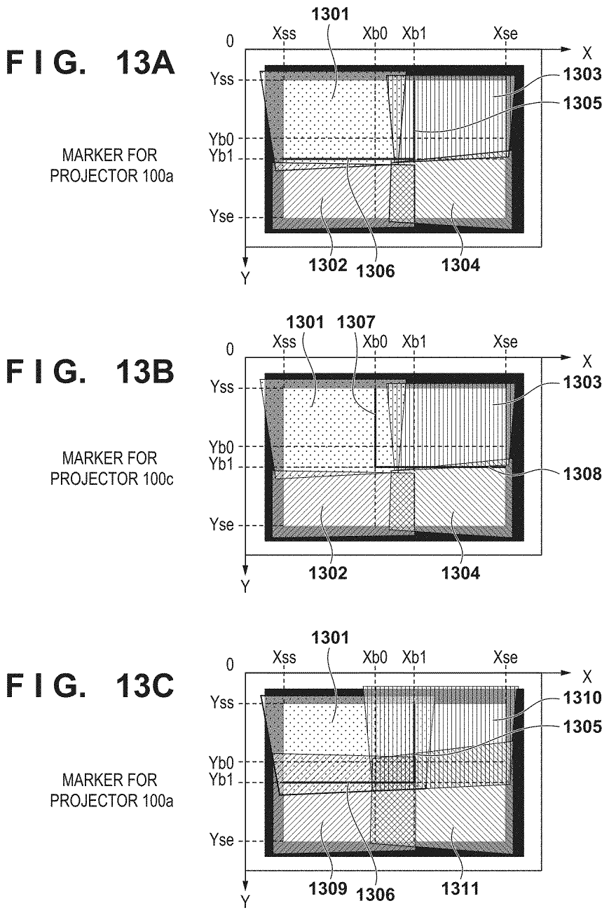

FIG. 13A shows an example of the relationship between markers and the projection areas of the projectors in the case where a marker projection projector cannot be determined. For example, here, if a predetermined ratio or more g 50% or more) of the projection range of a certain marker can be covered by the projection area of one or more projectors other than the projector whose position is to be adjusted, it is assumed that a marker projection projector can be determined for that marker. Also, assume that the projector 100a is the projector whose installation position is to be adjusted, and that the installation positions of the projectors 100b to 100d have not yet been adjusted.

Markers 1305 and 1306 serve as guides for the target projection area of the projector 100a, and the entirety of the projection range of the marker 1305 is included in a projection area 1302 of the projector 100c. However, no portion whatsoever of the projection range of the marker 1306 is included in projection areas 1302 and 1304 of the projectors 100b and 100d, and less than 50% is included in a projection area 1303 of the projector 100c. For this reason, in step S908, the CPU 201 cannot determine a marker projection projector for the marker 1306.

In this case, in step S1201, the CPU 201 determines that a marker projection projector has not been determined for one or more markers, and thus moves to the processing of step S912. Then, when returning from step S912 to step S908, the CPU 201 changes the projector targeted for installation position adjustment from the projector 100a to any one of the projectors 100b to 100d whose installation positions have not yet been adjusted. Here, assume that it is determined that the target projector is to be changed to the projector 100c.

FIG. 13B shows markers 1307 and 1308 for adjusting the installation position of the projector 100c in the state where the projection areas of the projectors are similar to those in FIG. 13A. In this case, the entirety of the projection range of the marker 1307 is included in the projection area 1301 of the projector 100a. On the other hand, none of the projectors have a projection area that includes 50% or more of the projection range of the marker 1308. However, if the portion of projection range of the marker 1308 that is included in the projection area 1301 of the projector 100a and the portion that is included in the projection area 1304 of the projector 100d are combined, the combined portion is 50% or more of the projection range. Accordingly, in step S908, the CPU 201 determines the projector 100a to be the marker projection projector for the marker 1307, and determines the projectors 100a and 100d to be the marker projection projectors for the marker 1308. In this case, in step S1201, the CPU 201 determines that a marker projection projector has been determined for all of the markers, and then executes the processing of step S909 onward.

FIG. 13C shows the positional relationship between the projection areas of the projectors and markers 1035 and 1306 in the case where the installation positions of the projectors 100b to 100d have been adjusted, and the installation position of the projector 100a is to be adjusted again. Because the installation positions of the projectors 100b to 100d have been adjusted, projection areas 1309 to 1311 thereof include the respective target projection areas. Accordingly, the entirety of the projection range of the marker 1306, for which a marker projection projector could not be determined in the state shown in FIG. 13A, is included in the projection area 1309 of the projector 100b. Also, the entirety of the projection range of the marker 1305 is still included in the projection area 1310 of the projector 100c. Note that although the projection area of the projector 100d also includes portions of the projection ranges of the assist markers 1305 and 1306, a smaller number of marker projection projectors is desirable in view of the number of times that screen generation and command transmission are performed. For this reason, in step S908, the CPU 201 determines that the projectors 100b and 100c are the marker projection projectors for the markers 1305 and 1306.

In step S1201, the CPU 201 determines that a marker projection projector has been determined for all of the markers, and then executes the processing of step S909 onward. Thereafter, in step S912, the CPU 201 determines that installation position adjustment has been performed for all of the projectors, and then ends the installation assistance processing.

Note that in the present embodiment, it is described that the projectors targeted for installation position adjustment are selected one-by-one, and if a marker projection projector cannot be determined (a marker cannot be projected), the projector targeted for installation position adjustment is changed. However, the projector targeted for installation position adjustment may be determined and/or changed based on other conditions. For example, a configuration is possible in which the sizes of the projection areas of the projectors in the camera coordinate plane are calculated, and installation position adjustment is performed in order of smallest size.

As described above, according to the present embodiment, installation position adjustment is begun with a projector for which the indicators serving as target projection area guides can be projected by another projector. For this reason, in addition to the effects of the first embodiment, it is possible to perform installation position adjustment even in a situation where the projection areas of some of the projectors are large.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-222683, filed on Nov. 28, 2018, which is hereby incorporated by reference herein in its entirety.

What is claimed is:

1. A projection control apparatus for controlling projection performed using projectors, the projection control apparatus comprising one or more processors that execute a program stored in a memory and function as:
a detection unit configured to, for each of the projectors, detect a projection area, being on a projection surface, in which an optical image is projected, based on a captured image of the projection surface; and
a control unit configured to cause an indicator indicating a target projection area for one of the projectors to be displayed by one or more other projectors,
wherein the control unit determines a projector that is to project the indicator from among the one or more other projectors based on a detection result of the detection unit.

2. The projection control apparatus according to claim 1,
wherein the control unit determines the projector that is to project the indicator to be, from among the one or more other projectors, one projector that can project a predetermined ratio or more of the indicator or a combination of two or more projectors that can together project the predetermined ratio or more of the indicator.

3. The projection control apparatus according to claim 1,
wherein if the control unit cannot determine the projector that is to project the indicator, the control unit changes the projector for which the indicator is to be displayed.

4. The projection control apparatus according to claim 1,
wherein the projection performed using the projectors is multi-projection in which projection areas are projected side-by-side such that portions of adjacent projection areas are overlapped with each other.

5. The projection control apparatus according to claim 1,
wherein the indicator is an image that indicates an edge of the target projection area.

6. The projection control apparatus according to claim 1,
wherein the control unit outputs a message that prompts a user to adjust a position of the one projector such that the indicator is included in the projection area of the one projector.

7. The projection control apparatus according to claim 6,
wherein the control unit causes the message to be projected by the one projector.

8. The projection control apparatus according to claim 6,
wherein the control unit causes the message to be displayed on a display apparatus of the projection control apparatus.

9. The projection control apparatus according to claim 1,
wherein the control unit furthermore causes the one projector to display an indicator that indicates a range in which a vertex of the projection area of the one projector can move.

10. The projection control apparatus according to claim 1,
wherein the projection areas of the projectors are automatically aligned with a corresponding target projection area in accordance with a user instruction.

11. A control method of projection performed using projectors, the control method comprising:
detecting, for each of the projectors, a projection area, being on a. projection surface, in which an optical image is projected, based on a captured image of the projection surface; and
causing an indicator indicating a target projection area for one of the projectors to be displayed by one or more other projectors,
wherein in the displaying, a projector that is to project the indicator from among the one or more other projectors is determined based on a detection result of the detecting.

12. A non-transitory computer-readable medium having stored thereon a program for causing a computer to function as a projection control apparatus for controlling projection performed using projectors that comprises:
a detection unit configured to, for each of the projectors, detect a projection area, being on a projection surface, in which an optical image is projected, based on a captured image of the projection surface; and
a control unit configured to cause an indicator indicating a target projection area for one of the projectors to be displayed by one or more other projectors,
wherein the control unit determines a projector that is to project the indicator from among the one or more other projectors based on a detection result of the detection unit.
